(19) United States
(12) Patent Application Publication
(10) Pub. No.: US 2024/0314249 A1
(43) Pub. Date: Sep. 19, 2024

(54) RECORDING DEVICE

(71) Applicant: SEIKO EPSON CORPORATION, Tokyo (JP)

(72) Inventor: Masaharu IWAMOTO, SHIOJIRI-SHI (JP)

(21) Appl. No.: 18/605,559

(22) Filed: Mar. 14, 2024

(30) Foreign Application Priority Data
Mar. 16, 2023 (JP) 2023-041685

(51) Int. Cl. H04N 1/00

(52) U.S. Cl. CPC H04N 1/00514; H04N 1/00037; H04N 1/00082; H04N 1/00496; H04N 1/00392

(57) ABSTRACT

Provided is a recording device including a movable panel unit provided in an angle adjustable manner and configured to be used to perform various operations. The recording device includes a panel rotation unit configured to rotate the movable panel unit to change an angle of the movable panel unit, a face position information acquisition unit configured to acquire information about a position of a face of a user, and a control unit. The control unit rotates the panel rotation unit to adjust the angle of the movable panel unit based on the information acquired by the face position information acquisition unit.

The present application is based on, and claims priority from JP Application Serial Number 2023-041685, filed Mar. 16, 2023, the disclosure of which is hereby incorporated by reference herein in its entirety.

### BACKGROUND

### 1. Technical Field

The present disclosure relates to a recording device.

### 2. Related Art

Examples of this type of recording device include a recording device described in JP-A-2005-244497. JP-A-2005-244497 discloses a recording device including a panel control unit that automatically adjusts an angle of a touch panel to an angle suitable for each user when the user stands in front of the recording device. A desired angle of the touch panel is determined by reading information of an ID card in which personal information is recorded, such as a memory card carried by each user, using an information reading unit and identifying each user based on the read information. The panel control unit automatically adjusts the touch panel to an angle corresponding to the identified user.

The known recording device has a problem in that when the user does not carry the ID card, that is, when the user forgets to bring the ID card, the recording device cannot recognize the user and cannot automatically adjust the angle of the touch panel.

### SUMMARY

In order to solve the above problems, a recording device according to an aspect of the present disclosure is a recording device including a movable panel unit provided in an angle adjustable manner and configured to be used to perform various operations, the recording device including a panel rotation unit configured to rotate the movable panel unit to change an angle of the movable panel unit, a face position information acquisition unit configured to acquire information about a position of a face of a user, and a control unit, in which the control unit rotates the panel rotation unit to adjust the angle of the movable panel unit based on the information acquired by the face position information acquisition unit.

### BRIEF DESCRIPTION OF THE DRAWINGS

FIG. 1 is an external perspective view of a recording device according to a first embodiment.

FIG. 2 is a schematic diagram illustrating a configuration of main parts of the first embodiment.

FIG. 3 is a configuration diagram for describing an electrical configuration of a control unit according to the first embodiment.

FIG. 4 is a flowchart for describing a flow of control by the control unit according to the first embodiment.

### DESCRIPTION OF EMBODIMENTS

The present disclosure will first be schematically described below.

In order to solve the above problems, a first aspect of a recording device according to the present disclosure is a recording device including a movable panel unit provided in an angle adjustable manner and configured to be used to perform various operations, the recording device including a panel rotation unit configured to rotate the movable panel unit to change an angle of the movable panel unit, a face position information acquisition unit configured to acquire information about a position of a face of a user, and a control unit, in which the control unit rotates the panel rotation unit to adjust the angle of the movable panel unit based on the information acquired by the face position information acquisition unit.

Here, the “face position information acquisition unit configured to acquire information about a position of a face of a user” is, for example, a face authentication camera, a face recognition camera, or the like, but in this specification, for example, it is used to mean that any unit that can determine the presence of a human face in an image obtained by photographing with a camera and can identify in what direction the face is located with respect to the camera may be used. Also, it is not limited to a camera and includes a unit that can acquire information about the presence or absence and a position of a face from information obtained in a non-contact manner without coming into contact with a target.

According to this aspect, the control unit is configured to adjust the angle by driving the panel rotation unit to rotate the movable panel unit based on the information acquired by the face position information acquisition unit. Thus, the angle of the movable panel unit can be adjusted to suit the user using only the information about the position of the face of the user without requiring an ID card as the known art. In addition, even when personal information of the user is not stored in advance in a storage unit as in the known art, by acquiring position information of the face of a person that uses the recording device, the angle of the movable panel unit can be adjusted to suit the user.

Further, it is hygienic because there is almost no need to touch the movable panel unit with a hand in order to rotate the movable panel unit.

A second aspect of the recording device according to the present disclosure is an aspect depending on the first aspect, in which the face position information acquisition unit is provided at the movable panel unit.

According to this aspect, the face position information acquisition unit is provided in the movable panel unit. Thus, control for adjusting the angle is simplified as compared to a case in which the information about the position of the face to be acquired for adjusting the angle of the movable panel unit is provided at a different location from the movable panel unit. In addition, it is possible to inhibit an increase in size.

A third aspect of the recording device according to the present disclosure is an aspect depending on the second aspect, further including a motion sensor configured to detect the user that uses the recording device, in which when the motion sensor detects the user, the control unit changes the face position information acquisition unit from an OFF state to an ON state. Further, this aspect can also depend on the first aspect.

According to this aspect, the control unit changes the face position information acquisition unit from the OFF state to the ON state when the motion sensor detects the user. Thus, when the movable panel unit is not used, the face position information acquisition unit such as an authentication camera can be set to be in the OFF state, and thus power saving can be achieved as compared to a case in which the face position information acquisition unit is left in the ON state. In addition, when the user uses the movable panel unit, the motion sensor detects approach of the user and changes the face position information acquisition unit to be in the ON state, and thus the movable panel unit is automatically adjusted to an angle suitable for the user.

A fourth aspect of the recording device according to the disclosure is an aspect depending on the third aspect, in which when the motion sensor detects the user, the control unit rotates the movable panel unit to move the face position information acquisition unit to a position at which the information is acquirable by the face position information acquisition unit.

According to this aspect, the control unit rotates the movable panel unit so that the face position information acquisition unit moves to the position at which the information is acquirable when the motion sensor detects the user. Thus, when the face position information acquisition unit is not used, it can be place at a non-exposed position to avoid being touched carelessly by the user. In addition, when the user comes closer to the recording device and the motion sensor detects the approach, the face position information acquisition unit automatically starts acquiring the information, and the movable panel unit can be automatically adjusted to an angle suitable for the user.

A fifth aspect of the recording device according to the present disclosure is an aspect depending on any one of the first to fourth aspects, in which when information indicating that a load equal to or greater than a certain level is detected is sent while the panel rotation unit is driven to automatically adjust the angle of the movable panel unit, the control unit stops driving the panel rotation unit.

According to this aspect, when the information indicating that the load equal to or greater than the certain level is detected is sent while the angle of the movable panel unit is automatically adjusted, driving of the panel rotation unit is stopped. Thus, it is possible to reduce the risk of the movable panel unit provided with the face position information acquisition unit malfunctioning.

A sixth aspect of the recording device according to the disclosure is an aspect depending on any one of the first to fourth aspects, in which the control unit is configured to select an automatic adjustment mode in which the angle of the movable panel unit is automatically adjusted and a manual adjustment mode in which the angle of the movable panel unit is manually adjusted without using the automatic adjustment mode. Further, this aspect can also depend on the fifth aspect.

According to this aspect, the control unit can select the automatic adjustment mode and the manual adjustment mode. Thus, the user can appropriately use them.

### EMBODIMENTS

Embodiments of a recording device according to the present disclosure will be specifically described below based on the drawings. In the following description, three axes that are perpendicular to each other will be referred to as an X axis, a Y axis, and a Z axis as illustrated in each figure. Directions indicated by arrows of the three axes (X, Y, and Z) are +directions of the respective directions, and opposite directions are −directions. The Z axis direction corresponds to a vertical direction, that is, a direction in which gravity acts, the +Z direction indicates a vertically upward direction, and the −Z direction indicates a vertically downward direction. The X axis direction and the Y axis direction correspond to horizontal directions. The +Y direction indicates a forward direction of the device, and the −Y direction indicates a rearward direction of the device. The +X direction indicates a rightward direction of the device, and the −X direction indicates a leftward direction of the device.

### First Embodiment

A multi-function device 1 of this embodiment is a recording device having functions of a copying machine, an image scanner, and a facsimile. Here, the recording device is an ink-jet printer.

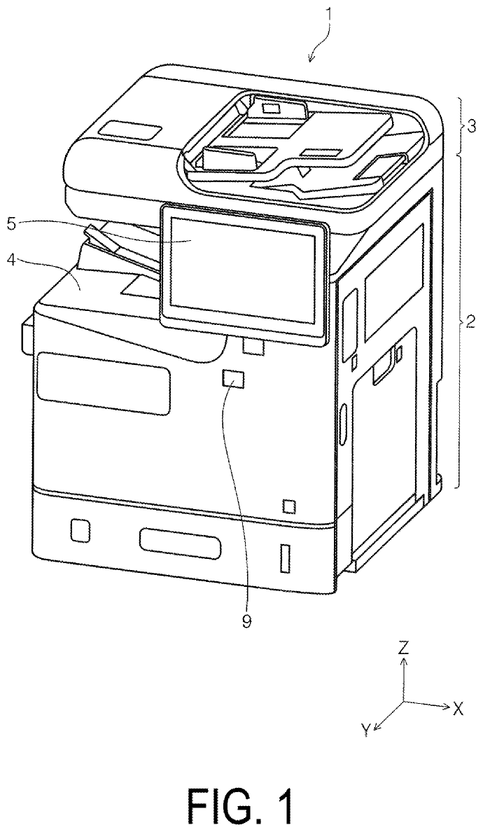

As illustrated in FIG. 1, in this multi-function device 1, a multi-function unit 3 having functions of a copying machine, an image scanner, and a facsimile is disposed above the recording device 2. A movable panel unit 5, which is a touch panel for performing various operations, is provided at a front surface of the multi-function device 1 in an angle adjustable manner. In FIG. 1, reference numeral 4 denotes a discharge receiving unit, and a medium such as paper on which recording has been performed by the recording device 2 is discharged to the discharge receiving unit 4.

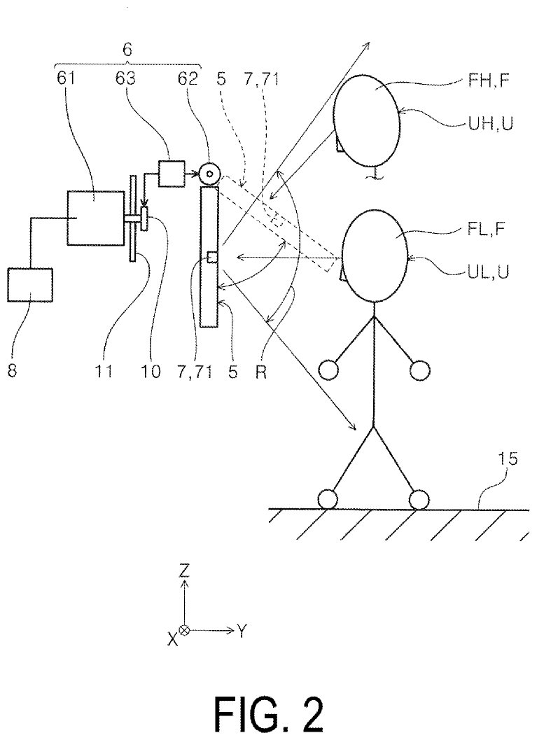

As illustrated in FIG. 2, in this embodiment, a panel rotation unit 6 that rotates the movable panel unit 5 to change its angle, a face position information acquisition unit 7 that can acquire information about a position of a face F of a user U, and a control unit 8 are provided. The control unit 8 is configured to adjust the angle of the movable panel unit 5 by rotating the panel rotation unit 6 based on the information about the position of the face F acquired by the face position information acquisition unit 7. In FIG. 2, reference numeral 15 denotes a floor on which the multi-function device 1 is placed.

Here, a relationship between the information about the position of the face F and an amount of adjusting the angle of the movable panel unit 5, that is, an amount of rotating the movable panel unit 5, is set in advance in the form of a table or a relational expression.

### Panel Rotation Unit

In this embodiment, as illustrated in FIG. 2, the panel rotation unit 6 includes a motor 61, a hinge unit 62 that holds the movable panel unit 5 so that its angle can be changed, and a power transmission mechanism 63 that transmits rotational power of the motor 61 to the hinge unit 62. The motor 61 is coupled to one end side of the power transmission mechanism 63 via a pinion 10 to be able to transmit power. In addition, a gear (not illustrated) is attached to the hinge unit 62. This gear is coupled to the other end side of the power transmission mechanism 63 to be able to transmit the power.

That is, a configuration is adopted in which rotation of the motor 61 is transmitted from the pinion 10 to the gear of the hinge unit 62 via the power transmission mechanism 63 and rotation of the gear can rotate the movable panel unit 5 to adjust the angle.

### Face Position Information Acquisition Unit

In this embodiment, a face authentication camera 71 is used for the face position information acquisition unit 7. The face authentication camera 71 determines whether the face F of the user U that is a human is present in an image reflected in a photographable region R using existing image data of eyes, noses, and mouths. Further, in what direction the face F is located with respect to the authentication camera 71 is identified. Thus, the face authentication camera 71 can acquire information about the position of the face F of the user U. Here, in order to make the description easier to understand, the user U will be described as standing on his or her feet on the floor 15 or sitting on a wheelchair or the like, but this is not an essential condition. It is sufficient if the position of the face F of the user U can be identified when the movable panel unit 5 is operated.

Also, the face authentication camera 71 is normally used to perform identification of the person with the face F by comparing the person with persons registered in advance, but in the present disclosure, there is no need to perform identification of a person, and therefore there is no need to register persons in advance. For the face position information acquisition unit 7, a face recognition camera similar to a face authentication camera can also be used. When this face recognition camera is used, it is also used to acquire the position of the face F.

That is, the face position information acquisition unit 7 may be any unit as long as it can determine from an image captured by a camera that a human face F is present in the image and can further identify in what direction the face F is located with respect to the camera. In addition, it is not limited to a camera, and a unit that can acquire information about the presence or absence and a position of the face F from information obtained in a non-contact manner without coming into contact with a target can also be adopted as the face position information acquisition unit 7.

Also, as illustrated in FIG. 2, in this embodiment, the face authentication camera 71 serving as the face position information acquisition unit 7 is provided in the movable panel unit 5. That is, the face authentication camera 71 is attached so that, when the movable panel unit 5 rotates, a position of the face authentication camera 71 also moves integrally therewith by an amount corresponding to the rotation of the movable panel unit 5.

Further, in this embodiment, a configuration is adopted in which the movable panel unit 5 is rotated so that the face F is placed at a center of the image captured by the face authentication camera 71, and in this state, the angle of the movable panel unit 5 is changed such that the face F of the user U is reflected facing the front. That is, a configuration is adopted in which, by rotating the movable panel unit 5 such that the face F of the user U is placed at the center of the image of the face authentication camera 71, the movable panel unit 5 is adjusted to an angle suitable for the user U. Thus, control of adjusting the angle is simplified as compared to a case in which the face authentication camera 71 is provided at a different location from the movable panel unit 5.

Also, the face position information acquisition unit 7 may be provided in a different portion from the movable panel unit 5. In addition, a configuration may be adopted in which, based on information at the stage of identifying the position of the face F in the image captured by the face authentication camera 71, the angle of the movable panel unit 5 may be adjusted so that the face F of the user U is reflected facing the front.

### Motion Sensor

Also, as illustrated in FIG. 2, in this embodiment, the multi-function device 1 includes a motion sensor 9 that detects the user U that uses the multi-function device 1 at a front surface portion thereof. The motion sensor 9 is a general type that can detect approach of the user U using infrared rays.

The control unit 8 is configured to change the face authentication camera 71 serving as the face position information acquisition unit 7 from the OFF state to the ON state when the motion sensor 9 detects the approach of the user U. That is, in this embodiment, when the user U does not approach the multi-function device 1, the face authentication camera 71 is not used, and thus the face authentication camera 71 is set to the OFF state. In addition, when the user U approaches the multi-function device 1, the control unit 8 changes the face authentication camera 71 to be in the ON state so that the position information of the face F of the user U can be acquired.

Also, the motion sensor 9 may not be provided. In that case, the face authentication camera 71 is kept in the ON state.

Further, in this embodiment, the control unit 8 is configured to move the face authentication camera 71 serving as the face position information acquisition unit 7 to a position at which the position information of the face F of the user U can be acquired when the motion sensor 9 detects the user U. Here, the face authentication camera 71 is provided in the movable panel unit 5 as follows. The face authentication camera 71 is configured to be able to appear and disappear so that it can be switched between an “exposed position” when photographing is performed, that is, during photographing, and a “hidden position” during not photographing. In the hidden state, since there is no risk of other objects or the user U carelessly touching it, there is little risk of damage.

In addition, instead of the switching structure between the “exposed” and “hidden” states, a rotation range of the movable panel unit 5 may be configured to be able to move to a storage position at which the face authentication camera 71 cannot acquire the position information of the face F of the user U.

Also, the face authentication camera 71 may be held at a position at which the position information of the face F of the user U can be always acquired.

Also, in this embodiment, the control unit 8 is configured to stop driving the panel rotation unit 6 when information indicating that a load equal to or greater than a certain level is detected is sent while the angle of the movable panel unit 5 is automatically adjusted by driving the panel rotation unit 6. Here, detection of the “load equal to or greater than a certain level” is performed by sensing a change in a current of the motor 61.

In addition, when the movable panel unit 5 is not actually rotated even though the movable panel unit 5 should be rotated in accordance with a control signal from the control unit 8, the image captured by the authentication camera 71 also remains unchanged. Information about a state in which the image does not change may be used for detection of the “load equal to or greater than a certain level”.

### Electrical Configuration of Control Unit

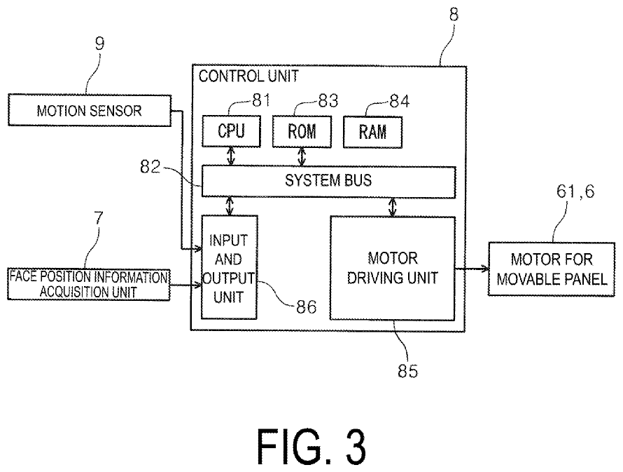

Next, an electrical configuration of the control unit 8 in the multi-function device 1 of this embodiment will be described based on FIG. 3. The control unit 8 is provided with a CPU 81 that manages control of the entire multi-function device 1. The CPU 81 is coupled via a system bus 82 to a ROM 83 that stores various control programs, maintenance sequences, and the like executed by the CPU 81, and to a RAM 84 that can temporarily store data.

In addition, the CPU 81 is coupled a motor driving unit 85 via the system bus 82. The motor driving unit 85 is coupled to the motor 61 for rotating the movable panel unit 5. Further, the CPU 81 is coupled an input and output unit 86 via the system bus 82. The input and output unit 86 is coupled to the face position information acquisition unit 7 and the motion sensor 9. The input and output unit 86 is also configured to be able to be coupled to a personal computer (not illustrated) and is configured to be able to input various data to the multi-function device 1 from the outside.

Also, the control unit 8 of the multi-function device 1 includes, for example, a head driving unit or the like for controlling driving of other constituent elements such as the recording device 2, but all of them are not illustrated in order to avoid complication of the drawing.

### Flow of Control by Control Unit of First Embodiment

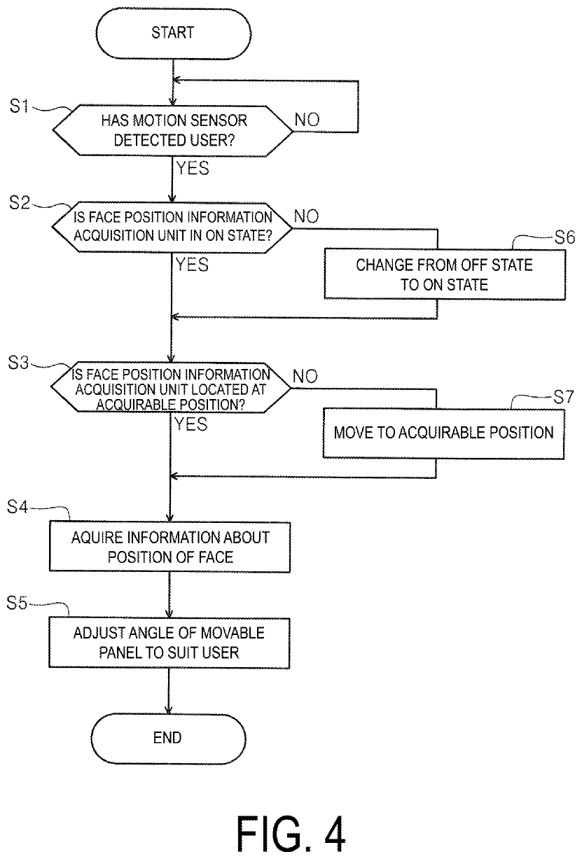

A control flow of the control unit when the user U approaches the multi-function device 1 will be described based on a flowchart of FIG. 4.

When the user U approaches the multi-function device 1, the motion sensor 9 detects the approach in step S1, and the processing proceeds to step S2. In step S2, it is determined whether the authentication camera 71 serving as the face position information acquisition unit 7 is in the ON state. If the determination is Yes, power supply of the authentication camera 71 is in the ON state and photographing is possible, and thus the processing proceeds to step S3. In step S3, it is determined whether the face authentication camera 71 is located at the position at which the information about the position of the face F of the user U can be acquired. If Yes, the processing proceeds to step S4. In step S4, the face authentication camera 71 captures an image of the user U and acquires the information about the position of the face F. Here, if the user U is a person that operates the movable panel unit 5, the position of the face F does not substantially change for a certain period of time at a position at which the user U sees the movable panel unit 5, and thus the information about the position of the face F may be acquired in the image in that state. Then, the processing proceeds to step S5, in which the angle of the movable panel unit 5 is adjusted to match the position of the face F of the user U, that is, so that the user U can easily see the movable panel unit 5, and the movable panel unit 5 is held at that angle. Thus, the user U can perform operations while viewing the movable panel unit 5 substantially from the front.

If No in step S2, the processing proceeds to step S6. In step S6, power supply of the authentication camera 71 is changed from the OFF state to the ON state, and the processing proceeds to step S3.

If No in step S3, the processing proceeds to step S7. In step S7, the face authentication camera 71 is moved to the position at which the information about the position of the face F of the user U can be acquired, and the processing proceeds to step S4.

### For Tall User and Short User.

As illustrated in FIG. 2, when the user U is a tall person UH, the authentication camera 71 acquires a position of a face FH, and the movable panel unit 5 is rotated so that the face FH is placed at the center of the image of the authentication camera 71. Thus, the movable panel unit 5 rotates to the position indicated by the broken line in FIG. 2 and is held at that position, and the user UH can perform operations from substantially in front of the movable panel unit 5. On the other hand, when the user U is a short person UL, the authentication camera 71 acquires a position of a face FL, and the movable panel unit 5 is rotated so that the face FL is placed at the center of the image of the authentication camera 71. Thus, the movable panel unit 5 rotates to the position indicated by the solid line in FIG. 2 and is held at that position, and the user UL can perform operations from substantially in front of the movable panel unit 5.

Further, when a height of a user is between the user UH and the user UL, the angle of the movable panel unit 5 is between the position indicated by the solid line and the position indicated by the broken line in FIG. 2.

### Description of Operations of First Embodiment

(1) In this embodiment, the control unit 8 is configured to adjust the angle by driving the panel rotation unit 6 to rotate the movable panel unit 5 based on the information acquired by the face position information acquisition unit 7. Thus, the angle of the movable panel unit 5 can be adjusted to suit the user U using only the information about the position of the face F of the user U without requiring an ID card, unlike the known art. In addition, unlike the known art, even when personal information of the user is not stored in advance in a storage unit, by acquiring the position information of the face F of the person that uses the multi-function device 1, the angle of the movable panel unit 5 can be adjusted to suit the user U. Further, it is hygienic because there is almost no need to touch the movable panel unit 5 with a hand in order to rotate the movable panel unit 5.

(2) Also, in this embodiment, the face position information acquisition unit 7 is provided at the movable panel unit 5. Thus, the control for adjusting the angle of the movable panel unit 5 is simplified as compared to the case in which the information about the position of the face F to be acquired for adjusting the angle of the movable panel unit 5 is provided at a different location from the movable panel unit 5. In addition, it is possible to inhibit an increase in size.

(3) Further, in this embodiment, when the motion sensor 9 detects the user U, the control unit 8 changes the face position information acquisition unit 7 from the OFF state to the ON state. Thus, when the movable panel unit 5 is not used, the face position information acquisition unit 7 such as the authentication camera 71 can be set to be in the OFF state, and thus power saving can be achieved as compared to the case in which the face position information acquisition unit 7 is left in the ON state. In addition, when the user U uses the movable panel unit 5, the motion sensor 9 detects the approach of the user U and changes the face position information acquisition unit 7 to be in the ON state, and thus the movable panel unit 5 is automatically adjusted to an angle suitable for the user U.

(4) Also, in this embodiment, when the motion sensor 9 detects the user U, the control unit 8 rotates the movable panel unit 5 to move the face position information acquisition unit 7 to a position at which the information can be acquired by the face position information acquisition unit 7. Thus, when the face position information acquisition unit 7 is not used, it can be placed at the non-exposed position to avoid being touched carelessly by the user U. In addition, when the user U comes closer to the multi-function device 1 and the motion sensor 9 detects the approach, the face position information acquisition unit 7 is moved to the position at which the information can be acquired, the face position information acquisition unit 7 automatically starts acquiring the information, and the movable panel unit 5 can be automatically adjusted to an angle suitable for the user U. (5) In this embodiment, when the information indicating that a load equal to or greater than a certain level is detected is sent while the angle of the movable panel unit 5 is automatically adjusted, driving of the panel rotation unit 6 is stopped. Thus, it is possible to reduce the risk of the movable panel unit 5 provided with the face position information acquisition unit 7 malfunctioning.

### OTHER EMBODIMENTS

Although the multi-function device 1 according to the present disclosure basically has the configuration of the embodiment described above, it is of course possible to change or omit partial configurations within a range not departing from the gist of the present disclosure.

In the above embodiment, an ink-jet printer has been described as the recording device 2 of the multi-function device 1, but other printers may be used.

In addition, in the above embodiment, the structure in which the movable panel unit 5 includes the hinge unit 62 at the upper end portion and rotates in the vertical direction with the hinge unit 62 as a pivot point has been described, but the hinge unit 62 may be placed at a lower end thereof. Also, the hinge unit 62 may be disposed laterally to rotate in the horizontal direction.

In the above embodiment, the case in which the control unit 8 includes only the automatic adjustment mode for automatically adjusting the angle of the movable panel unit 5 has been described, but the control unit 8 may include a manual adjustment mode for manually adjusting the angle of the movable panel unit 5 without using the automatic adjustment mode and may be configured to allow the user to select each of the two modes. Thus, the user U can appropriately use them.

As described in the above embodiment, the control unit 8 automatically adjusts the angle of the movable panel unit 5, but the adjusted angle may make it difficult for the user to use the movable panel unit 5. Thus, an angle resetting unit may be further provided, and when the user U operates the angle resetting unit, the face position information acquisition unit 7 may acquire the information about the position of the face F of the user U again, and the angle may be adjusted again.

What is claimed is:

1. A recording device including a movable panel unit provided in an angle adjustable manner and configured to be used to perform various operations, the recording device comprising:
a panel rotation unit configured to rotate the movable panel unit to change an angle of the movable panel unit;
a face position information acquisition unit configured to acquire information about a position of a face of a user; and
a control unit, wherein
the control unit rotates the panel rotation unit to adjust the angle of the movable panel unit based on the information acquired by the face position information acquisition unit.

2. The recording device according to claim 1, wherein
the face position information acquisition unit is provided at the movable panel unit.

3. The recording device according to claim 2, further comprising
a motion sensor configured to detect the user that uses the recording device, wherein
when the motion sensor detects the user, the control unit changes the face position information acquisition unit from an OFF state to an ON state.

4. The recording device according to claim 3, wherein
when the motion sensor detects the user, the control unit rotates the movable panel unit to move the face position information acquisition unit to a position at which the information is acquirable by the face position information acquisition unit.

5. The recording device according to claim 1, wherein
when information indicating that a load equal to or greater than a certain level is detected is sent while the panel rotation unit is driven to automatically adjust the angle of the movable panel unit, the control unit stops driving the panel rotation unit.

6. The recording device according to claim 1, wherein
the control unit is configured to select an automatic adjustment mode in which the angle of the movable panel unit is automatically adjusted and a manual adjustment mode in which the angle of the movable panel unit is manually adjusted without using the automatic adjustment mode.
